(19) United States
(12) Patent Application Publication
(10) Pub. No.: US 2002/0066359 A1
(43) Pub. Date: Jun. 6, 2002

(54) Tone generator system and tone generating method, and storage medium

(76) Inventor: Takahiro Kawashima, Hamamatsu-shi (JP)

Correspondence Address: Pillsbury Winthrop LLP, Intellectual Property Group, Suite 2800, 725 South Figueroa Street, Los Angeles, CA, 90017-5406, US

(21) Appl. No.: 10/005,309

(22) Filed: Dec. 3, 2001

(30) Foreign Application Priority Data
Dec. 4, 2000 (JP) 2000-368427

(51) Int. Cl. G10H 1/06

(52) U.S. Cl. 84/622

(57) ABSTRACT

There is provided a tone generator system that is capable of generating various types of high-quality musical tones by means of waveform storage means with a small capacity using a tone generator based on the waveform memory method. A first waveform storage stores compressed waveform data. A decoder operates in response to tone color changing instruction data included in musical composition data to be reproduced, to read out from the first waveform storage the compressed waveform data corresponding to at least one tone color corresponding to the tone color changing instruction data and decode the readout compressed waveform data into waveform data in a pulse code modulation format. A second waveform storage stores the waveform data in the pulse code modulation format decoded by the decoder.

### BACKGROUND OF THE INVENTION

1. Field of the Invention

This invention relates to a tone generator system and tone generating method based on a waveform memory method, and a storage medium storing a program for implementing the method.

2. Description of the Related Art

A tone generator system is used in various kinds of equipment such as personal computers and game machines, and in recent years, the tone generator system has come to be used in mobile communication terminals such as cellular phones.

It is known that such tone generator system is based on various kinds of methods such as the waveform memory method (PCM), the FM method, the physical model method, the harmonic synthesizing method, the formant synthesizing method, and the VCO+VCF+VCA analog synthesizing method according to musical tone generation algorithms.

A tone generator based on the waveform memory method (PCM method) converts a musical tone waveform of a natural musical instrument or the like into a digital signal by sampling, stores the digital signal in a waveform memory, and reads out the stored waveform data to thus generate musical tones of various tone colors.

In order to generate musical tones having various types of tone colors or higher quality from the tone generator based on the waveform memory method, it is necessary to store a large amount of musical tone waveforms in the waveform memory. This requires the waveform memory to have a large storage capacity.

To address this problem, it has been proposed to store a compressed musical tone waveform sample in a compressed waveform storage means, read out compressed waveform data to be used from the compressed waveform storage means according to a key-on signal, and decode and store the data in a reproduced waveform storage means to generate musical tones (Japanese Laid-Open Patent Publication (Kokai) No. 06-348274).

It has also been proposed to provide a compressed waveform storage means that stores a musical tone waveform as compressed data and an initial waveform storage means that stores a musical tone waveform representing musical tones at the start of sounding without compressing it, and generating musical tones based on the musical tone waveform stored in the initial waveform storage means at first (U.S. Pat. No. 5,459,279 and Japanese Laid-Open Patent Publication (Kokai) No. 06-342291).

According to the method which reads out compressed waveform data from the compressed waveform storage means according to a key-on signal and decodes the waveform data without providing the above-mentioned initial waveform storage means, it is possible to reduce the storage capacity of the waveform storage means, but a time lag occurs due to the time required for decoding the compressed waveform data, thus resulting in degraded responsiveness of an electronic musical instrument or the like using the method, i.e. an increased time lag from the key-on to the sounding.

According to the method in which the initial waveform storage means storing an uncompressed musical tone waveform representing musical tones at the start of sounding is provided in addition to the compressed waveform storage means, the above-mentioned problem resulting from the time lag can be eliminated, but the need for provision of the initial waveform storage means increases the whole storage capacity required for storing waveform data.

Further, in the above described methods, the compressed waveform data is decoded and stored in a reproduced waveform storage means in response to a sounding instruction, and this increases a processing load due to the need for frequently decoding the waveform data and requires the reproduced waveform storage means to have a large storage capacity. That is, it is necessary to decode waveform data of all sounding channels capable of simultaneous sounding, and necessitates an area for storing the decoded data.

### SUMMARY OF THE INVENTION

It is therefore an object of the present invention to provide a tone generator system and tone generating method that is capable of generating various types of high-quality musical tones by means of waveform storage means with a small capacity using a tone generator based on the waveform memory method, and a storage medium storing a program for implementing the method.

It is another object of the present invention to provide a tone generator system and tone generating method that is capable of eliminating a time lag from the note-on to the start of sounding using a tone generator based on the waveform memory method in which compressed waveform data is stored, and a storage medium storing a program for implementing the method.

To attain the above objects, the present invention provides a tone generator system comprising a first waveform storage that stores compressed waveform data, a decoder that is responsive to tone color changing instruction data included in musical composition data to be reproduced, for reading out from the first waveform storage the compressed waveform data corresponding to at least one tone color corresponding to the tone color changing instruction data and for decoding the readout compressed waveform data into waveform data in a pulse code modulation format, and a second waveform storage that stores the waveform data in the pulse code modulation format decoded by the decoder.

In a preferred form of the present invention, the tone generator system further comprises a tone generator section that is responsive to sounding instruction data included in the musical composition data to be reproduced, for generating musical tones based on the waveform data in the pulse code modulation format stored in the second waveform storage.

Preferably, the second waveform storage is capable of storing waveform data inputted by a user.

Also preferably, the decoder is capable of decoding compressed audio stream data inputted from an external device.

To attain the above objects, the present invention also provides a tone generating method comprising a decoding step of reading out from a first waveform storage compressed waveform data corresponding to at least one tone color corresponding to tone color changing instruction data included in musical composition data to be reproduced and decoding the readout compressed waveform data into waveform data in a pulse code modulation format, in response to the tone color changing instruction data, and a waveform storing step of storing in a waveform storage the waveform data in the pulse code modulation format decoded in the decoding step.

To attain the above objects, the present invention further provides a program for executing a tone generating method stored in a storage medium readable by a computer, the program comprising a decoding module for reading out from a first waveform storage compressed waveform data corresponding to at least one tone color corresponding to tone color changing instruction data included in musical composition data to be reproduced and decoding the readout compressed waveform data into waveform data in a pulse code modulation format, in response to the tone color changing instruction data, and a waveform storing module for storing in a waveform storage the waveform data in the pulse code modulation format decoded by the decoding module.

According to the present invention, the compressed waveform data is decoded in advance in response to a program change message (tone color changing instruction data) so that it can be used as a tone generator waveform. This prevents the occurrence of a delay in sounding.

Further, the compressed waveform data is decoded and is expanded onto the second waveform storage in response to a program change message. This enables the same expanded waveform data to be shared by a plurality of tone colors to be sounded. This requires only a small capacity of a RAM that constitutes the second waveform storage, decreases the frequency with which the decoding process is carried out, and hence reduces the processing load.

Further, if a stream compressing method with a high compression rate is adopted, the amount of data stored in a ROM that constitutes the first waveform storage can be substantially reduced.

Further, the decoding means for decoding the stream-compressed waveform data may be also used for usual stream reproduction.

Further, although a RAM for storing user tone colors must be additionally provided in a conventional tone generator in order to use the user tone colors since the conventional tone generator usually has only a ROM as a waveform storage, the tone generator system according to the present invention is capable of using the RAM that constitutes the second waveform storage, for storing both preset tone colors and user tone colors.

The above and other objects, features, and advantages of the invention will become more apparent from the following detailed description taken in conjunction with the accompanying drawings.

### BRIEF DESCRIPTION OF THE DRAWINGS

FIG. 1 is a schematic block diagram showing the arrangement of a mobile communication terminal to which is applied a tone generator system according to an embodiment of the present invention;

FIG. 2 is a block diagram showing the internal configuration of a tone generator/decoder section 12 appearing in FIG. 1;

FIGS. 3A and 3B are diagrams useful in explaining data stored in a first waveform storage 13, wherein FIG. 3A shows data stored in the first waveform storage 13 and FIG. 3B shows data stored in a first tone color index table 40 in FIG. 3A;

FIGS. 4A and 4B are diagrams useful in explaining data stored in a second waveform storage 14, wherein FIG. 4A shows data stored in the second waveform storage 14 and FIG. 4B shows data stored in a second tone color index table 50 in FIG. 3A;

FIG. 5 is a flow chart showing a reproducing operation using preset tone colors in the tone generator system 10;

FIG. 6 is a diagram showing data stored in the second tone color index table 50 in a case where user tone colors are used with respect to specific MIDI channels;

FIG. 7 is a flow chart showing an operation carried out in a case where user tone colors are used for reproduction with respect to specific program numbers; and

FIGS. 8A-8C are diagrams useful in explaining a state in which data is stored in the second waveform storage during reproduction using a user tone color set.

### DESCRIPTION OF THE PREFERRED EMBODIMENTS

A preferred embodiment of the present invention will now be described with reference to the accompanying drawings.

A tone generator system according to the present invention can be applied to various kinds of electronic equipment such as electronic musical instruments, personal computers, and game machines, which are capable of generating musical tones. A description will be given of an embodiment of the present invention, wherein the tone generator system is applied to a mobile communication terminal such as a cellular phone and a PHS (Personal Handyphone System).

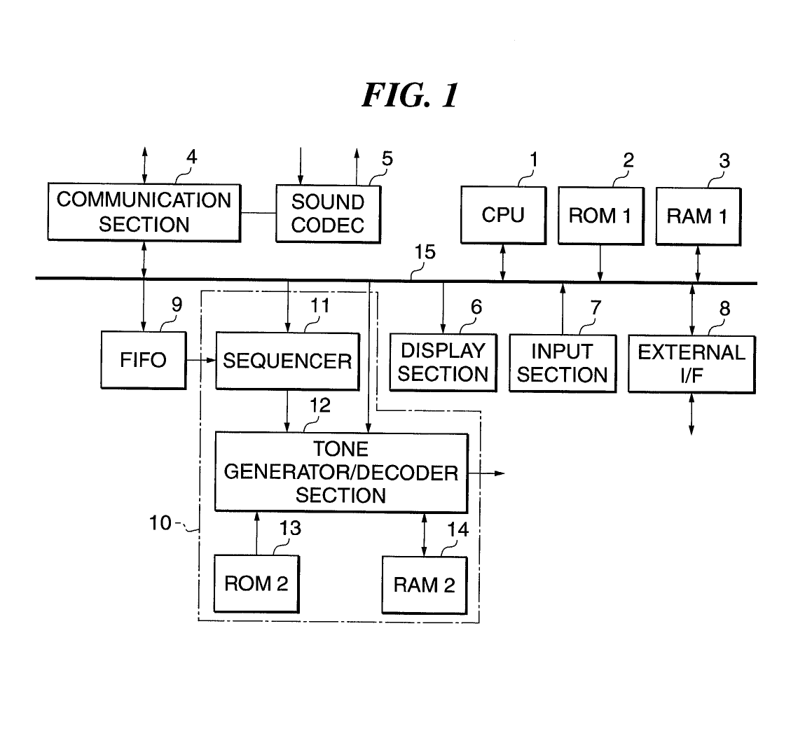

FIG. 1 is a schematic block diagram showing the arrangement of a mobile communication terminal to which is applied the tone generator system according to an embodiment of the present invention.

In FIG. 1, reference numeral 1 denotes a central processing unit (CPU) that controls the operations of the whole mobile communication terminal; 2, a first memory (ROM 1) composed of a ROM or the like storing a control program and a variety of constant data; 3, a second memory (RAM 1) composed of an EEPROM such as a flash memory and a RAM storing a variety of information and serving as a work area; 4, a communication section; 5, a sound coding and decoding circuit (sound CODEC) connected to a microphone and a speaker, not shown; 6, a display section; 7, an input section; 8, an external interface circuit (external I/F); and 9, a buffer (FIFO) composed of a FIFO or the like. A component 10 enclosed by a broken line is the tone generator system according to the present invention. The tone generator system 10 is comprised of a sequencer 11, a tone generator and decoder section (tone generator/decoder section) 12, a first waveform storage (ROM 2) 13 composed of a ROM, and a second waveform storage (RAM 2) 14 composed of a RAM. Further, reference numeral 15 denotes a bus for use in the transfer of data between the above-mentioned components.

The first waveform storage 13 stores tone color data of all preset tone colors used by the tone generator system 10, and in particular, waveform data of the respective tone colors is stored in a compressed form (compressed waveform data). Tone color data for use in a musical composition to be performed is stored in an uncompressed form in the second waveform storage 14, and musical tones are generated using the waveform data (PCM waveform data) stored in the second waveform storage 14.

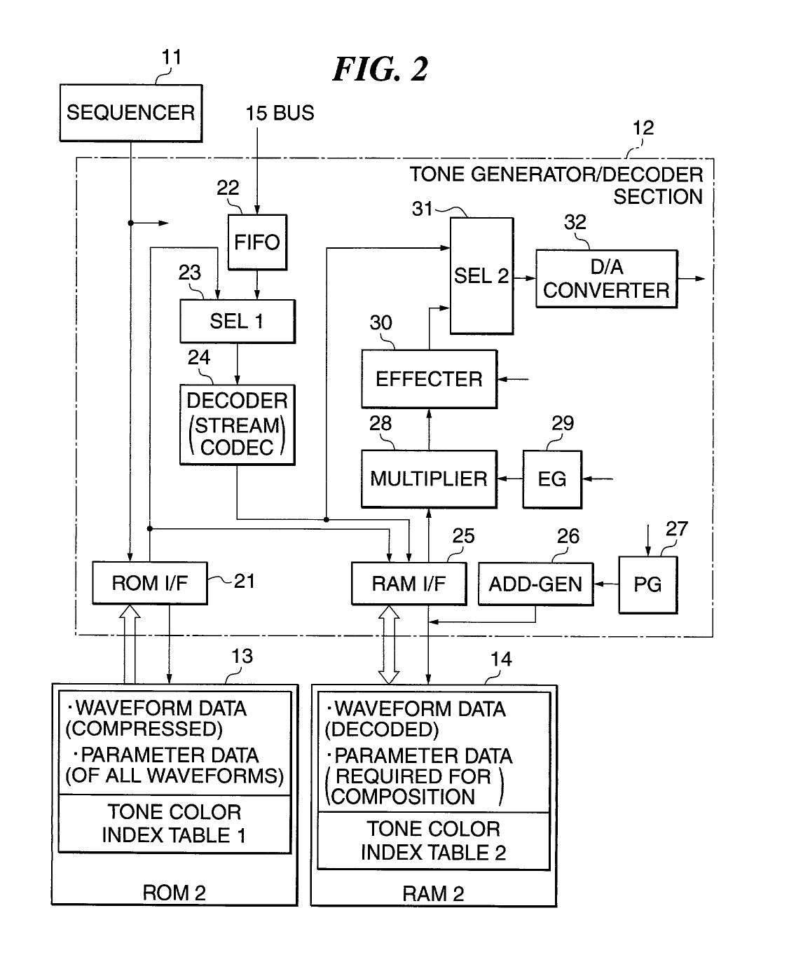

FIG. 2 is a block diagram showing the internal configuration of the tone generator/decoder section 12 in FIG. 1.

In FIG. 2, reference numeral 21 denotes a first memory interface circuit (ROM interface circuit, ROM I/F) for use in reading out data from the first waveform storage 13; 22, a buffer (FIFO) composed of, e.g. a FIFO, which receives audio stream data supplied from the bus 15; 23, a first selecting device (selector, SEL 1) that selectively supplies the compressed waveform data read out from the first waveform storage 13 and delivered via the ROM interface circuit 21 and the output from the buffer 22 to a decoder 24; 24, the decoder (stream CODEC) that decodes the compressed waveform data.

Reference numeral 25 denotes a second memory interface circuit (RAM interface circuit, RAM I/F) for use in reading and writing data from and into the second waveform device 14; 26, an address generator (ADD-GEN) that generates a read address at which the waveform data stored in the second waveform storage 14 is read out according to an address generated by a phase generator (PG) 27 when musical tones are generated; 27, the phase generator that generates an address updated by a phase update amount (F number) corresponding to a note number of a generated musical tone; 28, a multiplier that multiplies the waveform data read from the second waveform storage 14 by envelop data supplied from an envelop generator (EG) 29 when musical tones are generated; 29, the envelope generator; 30, an effecter that applies predetermined effects to the waveform data outputted from the multiplier 28; 31, a second selecting device (selector, SEL 2) that selectively outputs decoded waveform data from the decoder 24 and waveform data outputted from the effecter 30 to a digital-to-analog converter (D/A converter) 32; and 32, the D/A converter that converts the waveform data outputted from the second selecting device 31 into an analog signal. The output from the D/A converter 32 is amplified by an audio amplifier that is not illustrated, and is then outputted via the speaker. These components constitute a tone generator section.

The mobile communication terminal arranged in the above described manner has a function of reproducing a musical composition by means of the tone generator system 10 as well as an ordinary cellular phone function. Such a musical composition may be used for an incoming call melody, a hold sound, and a BGM during a phone call, and may also be appreciated when desired. Musical composition data (sequence data) for use in performing the musical composition is stored in advance in the first memory 2 if the musical composition is used for an incoming call melody or a hold sound as defaulted. The musical composition data may be acquired by downloading from an external musical composition server by radio communication via the communication section 4. The musical composition data may also be acquired by downloading from a personal computer connected to the mobile communication terminal via the external interface circuit 8. Further, the first memory 2 may store a musical composition data-producing/editing program so as to provide the mobile communication terminal itself with a function of producing and editing the musical composition data. The musical composition data downloaded or produced/edited in this manner is stored in the second memory 3.

It should be noted that the musical data may be formatted in any one of the SMF (standard MIDI (Musical Instruments Digital Interface) file) format, a simple format (SMAF (Synthetic Musical Mobile Application Format) specialized for mobile communication terminals, and the CMIDI (Compact MIDI), or the like) format, but the following description is based on an example of musical composition data in the SMF format. As is well known, the SMF format is comprised of a header chunk and at least one track chunk. The header chunk stores basic information on a file such as a format, the number of tracks, and a time unit; and the track chunk stores performance data composed of time information (delta time) representing time intervals between messages and message information. The message information includes MIDI event data including MIDI channel messages (e.g. a note-on message, a note-off message, a control change message, a program change message, a pitch bend message, a channel after-touch message), system exclusive event data containing MIDI system exclusive messages and the like, and meta event data including information on the entire performance, which is not included in the performance data. Usually, the program change message designating a tone of a corresponding MIDI channel is stored in predetermined timing (e.g. one beat) before the note-on message.

By using the tone generator system 10 according to the present invention constructed in the above described manner, it is possible to carry out the following three kinds of operations: 1) reproduction of musical composition data by a tone generator using preset tone colors stored in the first waveform storage 13, 2) reproduction of musical data by a tone generator using user tone colors, and 3) reproduction of audio stream data.

Specifically, the CPU 1 transfers musical composition data stored in the first memory 2 or the second memory 3 to the sequencer 11 via the buffer 9 according to a reproducing instruction. The sequencer 11 sequentially interprets messages included in the musical composition data, and transfers control information such as tone generator drive data (e.g. a note-on message, a note-off message, a note number, and a channel number) to the tone generator/decoder section 12 in predetermined timing. Incidentally, the CPU 11 supplies sequencer control information relating to the start and stop of the musical composition reproduction directly to the sequencer 11. According to a program change message (tone color changing instruction data) included in the musical composition data, compressed tone color data (compressed waveform data) of the corresponding tone color is read out from the first waveform storage 13 and is decoded by the decoder to be stored in the second waveform storage 14. The tone generator section of the tone generator/decoder section 12 generates and outputs musical tones using the tone color data (PCM waveform data) stored in the second waveform storage 14. This enables the above-mentioned 1) reproduction of musical composition data to be carried out using preset tone colors.

Further, generating musical tones by means of tone color data separately prepared by a user and stored previously in the second waveform storage 14 enables the above-mentioned 2) reproduction of musical composition data using desired user tone colors.

Further, since the decoder of the tone generator/decoder section 12 has the function of decoding the compressed waveform data as mentioned above, it is possible to reproduce longtime compressed waveform data (audio stream data) by means of the decoder. More specifically, the CPU 1 inputs audio stream data stored in the second memory 3 or audio stream data inputted via the communication section 4 or the external interface circuit 8 to the buffer 22 of the tone generator/decoder section 12, and decodes it by the decoder 24 and outputs the decoded data to the D/A converter 32 to thus enable the above-mentioned 3) sequential reproduction of audio stream data.

A detailed description will now be given of the operation of the above described tone generator system according to the present embodiment.

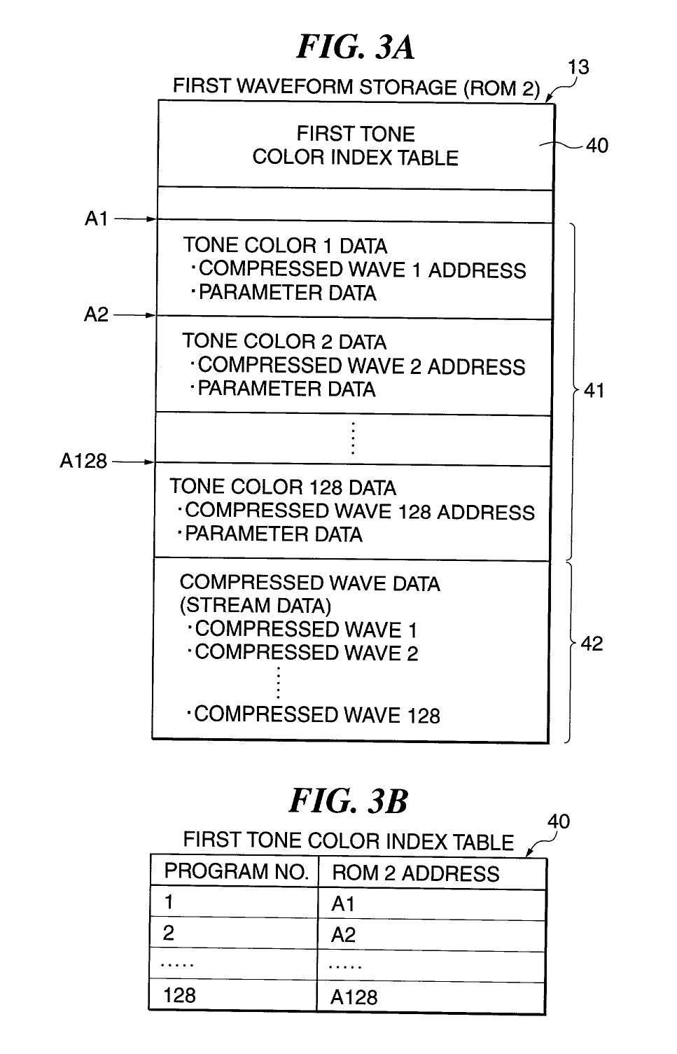

FIGS. 3A and 3B are diagrams useful in explaining data stored in the first waveform storage 13, wherein FIG. 3A shows data stored in the first waveform storage 13 and FIG. 3B shows data stored in a first tone color index table 40 appearing in FIG. 3A.

As stated previously, the first waveform storage 13 stores the tone color data of all the preset tone colors generated by the tone generator system 10, and among the tone color data, the waveform data is stored in a compressed form. In the following description, it is assumed that the first waveform storage 13 stores tone color data of 128 types of tone colors which may be designated by program number (7 bit) included in the MIDI program change message. It should be noted that the number of tone colors should not be limited to 128, but it may be determined arbitrarily as desired.

The waveform data may be compressed in any methods insofar as data stream of an audio signal is compressed, but preferably, the waveform data is compressed in a method in which data is compressed at a high compression rate, such as the MP3 (MEPG-1 Audio Layer 3) method, the AAC (MPEG-2, Advanced Audio Coding) method, the TwinVQ (Transform-domain Weighted Interleave Vector Quantization), the ATRAC (Adaptive Transform Acoustic Cording) method, and the ADPCM (Adaptive Differential Pulse Code Modulation) method. However, the decoder 24 should be designed suitably for the adopted compression method at least.

As shown in FIG. 3A, the first waveform storage 13 is comprised of the first tone color index table 40, a tone color data storage area 41, and a compressed waveform data storage area 42 that stores compressed waveform data corresponding to the respective tone colors.

FIG. 3B shows the data stored in the first tone color index table 40 in FIG. 3A. As shown in FIG. 3B, start addresses (A1, A2, . . . , A128) of storage areas that stores the tone color data corresponding to the respective tone colors are stored correspondingly to program numbers in the first tone color index table 40.

Tone color data of the respective tone colors are stored in the tone color data storage area 41, and each tone color data includes i) address information that specifies a storage area where compressed waveform data of the corresponding tone color is stored, i.e. information on a start address and end address of an area where the compressed waveform data is stored; and ii) parameter data of the corresponding tone color. As the parameter data, an end address and a loop start address represented as relative addresses from the start address of uncompressed PCM waveform data before being compressed into the compressed waveform data, envelop data, effect data, and a compression method and a compression rate for use in compressing the waveform data are stored. The end address and the loop start address are determined in advance according to the uncompressed PCM waveform data. If the adopted compression method and compression rate are fixed, it is unnecessary to store information on the compression method and the compression rate.

In the compressed waveform data storage area 42, compressed waveform data corresponding to each tone color is stored in an area specified by the address information included in the corresponding tone color data.

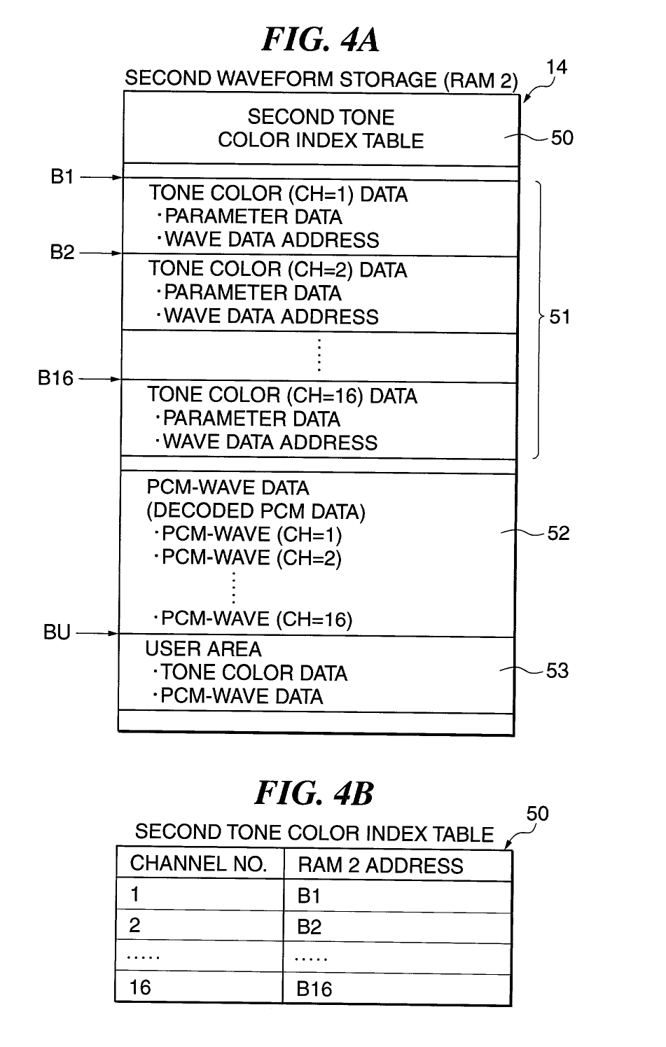

Referring next to FIGS. 4A and 4B, a description will be given of data stored in the second waveform storage 14.

FIGS. 4A and 4B are diagrams useful in explaining data stored in the second waveform storage 14, wherein FIG. 4A shows data stored in the second waveform storage 14 and FIG. 4B shows data stored in a second tone color index table 50 appearing in FIG. 3A.

As shown in FIG. 4A, the second waveform storage 14 is comprised of the second tone color index table 50, a tone color data storage area 51 for storing tone color data corresponding to the respective MIDI channels, a PCM waveform data storage area 52 for storing decoded PCM waveform data, and a user area 53 for storing tone color data separately prepared by the user and the corresponding PCM waveform data. It should be noted that the second tone color index table 50 should not necessarily be stored in the second waveform storage 14, but it may be provided in the sequencer 11 or the tone generator/decoder section 12.

FIG. 4B shows data stored in the second tone color index table 50 in FIG. 4A. As shown in the figure, the second tone color index table 50 stores start addresses of areas where tone color data assigned to the respective MIDI channels are stored. In the example shown in FIG. 4B, start addresses B1, B2, . . . of areas where respective tone color data are stored in the tone color data storage area 51 are recorded with respect to channel numbers 1, 2, . . . . This applies to the above-mentioned 1) reproduction using preset tone colors as described later.

The tone color data storage area 51 is intended to store tone color data corresponding to the respective MIDI channels. In the tone color data storage area 51, parameter data (e.g. an end address, a loop start address, envelop data, and effect data) for the respective tone colors and start addresses (waveform data addresses) of areas where PCM waveform data of the corresponding tone colors are stored. The end address and the loop start address in each parameter data are addresses in the second waveform storage 14, which are found by adding the end address and the loop start address represented by relative addresses from a start address included in each tone color data stored in the first waveform storage 13 to a start address (waveform data address) of an area where the corresponding compressed waveform data read from the first waveform storage 13 and decoded into PCM waveform data is stored in the second waveform storage 14.

The PCM waveform data storage area 52 is intended to store PCM waveform data of the respective channels obtained by decoding the compressed waveform data read from the first waveform storage 13 by the decoder 24. FIG. 4A shows a state in which decoded PCM waveform data of 16 MIDI channels from a channel 1 to a channel 16 is stored in the PCM waveform data storage area 52.

The user area 53 is intended to store tone color data separately prepared by the user (user tone colors), that is, store tone color data of the user tone colors and the corresponding PCM waveform data.

A description will now be given of the above described operations carried out in the tone generator system according to the present embodiment constructed in the above described manner.

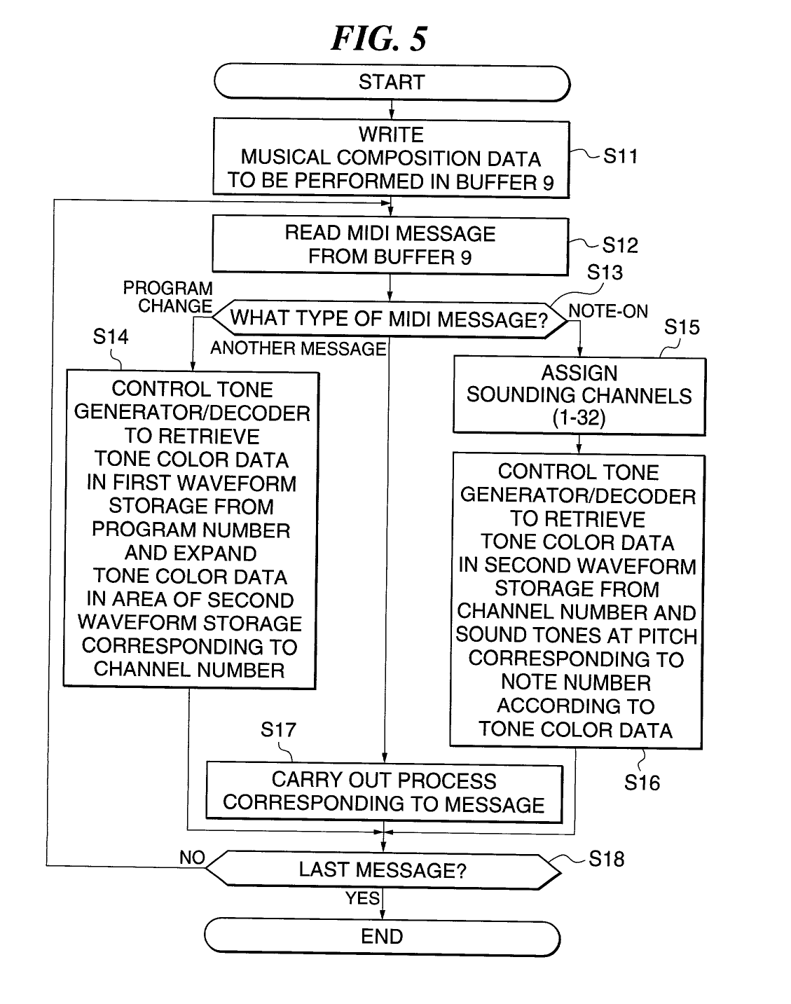

First, a description will be given of 1) a reproducing operation using preset tone colors with reference to a flow chart of FIG. 5.

FIG. 5 is a flow chart showing the reproducing operation using preset tone colors in the tone generator system 10 according to the present embodiment.

In response to an instruction for reproducing performance data stored in the first memory 2 or in the second memory 3, the CPU 1 instructs the sequencer 11 and the tone generator/decoder section 12 to start reproduction, and supplies the performance data (SMF data) stored in the first memory 2 or the second memory 3 to the buffer 9 (step S11).

The sequencer 11 sequentially reads the SMF data from the buffer 9 (step S12), and determines the type of the SMF data (step S13) to provide the tone generator/decoder section 12 with a control signal corresponding to an MIDI message included in the SMF data. According to the present embodiment, if the MIDI message is a program change message, tone color data corresponding to a program number included in the program change message is read out from the first waveform storage 13, and the compressed waveform data included in the readout tone color data is decoded into PCM waveform data by the decoder 24 to be stored in the second waveform storage 14 (step S14).

Specifically, an address (App) where the corresponding tone color data is stored is found by referring to the first tone color index table 40 in the first waveform storage 13 using a program number (pp) included in the program change message (Cnpp: “Cn” represents a status byte, “n” represents a MIDI channel, “pp” represents a program number) as a key, and the tone color data (compressed waveform address information and parameter data) is read out.

The parameter data of the corresponding tone color thus read from the first waveform storage 13 is stored in the tone color data storage area 15 of the second waveform storage device 13. At this time, a start address (Bn) of an area for storing the parameter data is determined, and this start address is written into an entry for the corresponding MIDI channel in the second tone color index table 50.

The compressed waveform data of the corresponding tone color is read out from the first waveform storage 13 according to the readout compressed waveform address information, and is supplied to the decoder 24 via the first selecting device 23. Then, the decoder 24 decodes the compressed waveform data, and the resulting PCM waveform data of the corresponding tone color is written into the PCM waveform data storage area 52 of the second waveform storage 14 via the RAM interface circuit 25. A start address of an area where the PCM waveform data is stored is written as a waveform data address in the tone color data storage area 51 for the corresponding MIDI channel (n).

If the read MIDI message is a note-on message (9nkkvv: “9n” represents a status byte indicating a noteon message, “n” represents a MIDI channel, “kk” represents a note number, and “vv” represents a velocity), the program proceeds to a step S15 wherein sounding channels of the tone generator section are assigned. The number of sounding channels in the tone generator/decoder section 12 may be set to an arbitrary number such as 16, 32, and 64.

The program then proceeds to a step S16 to carry out a note sounding process. More specifically, the second tone color index table 50 is retrieved according to a MIDI channel number (n) included in the note-on message to find the address of an area where tone color data of the corresponding tone color is stored in the second waveform storage 14. The tone color data (a start address, an end address, a loop address, envelop data, and effect data) is then read out, and is set to the corresponding positions as follows in order to make preparations for generating musical tones: The start address is set in the address generator 26, the end address and the loop start address are set in the phase generator 27, the envelop data is set in the envelop generator 29, and the effect data is set in the effecter 30. The address generator 26 then starts reading out waveform data of the corresponding tone color at the start address in the second waveform storage 14. An address at which the waveform data is read out is updated by a phase increment value (F number) converted from a note number included in the note-on message, and is updated to set the loop start address as an initial value after the address reaches the end address. The address outputted from the phase generator 27 is added to the start address in the address generator 26, and PCM waveform data of the corresponding MIDI channel is sequentially read out from the second waveform storage 14.

The PCM waveform data thus read out is multiplied by envelop information supplied from the envelop generator 29 by the multiplier 28, and the resulting PCM waveform data is multiplied by effect information by the effecter 30. The resulting PCM waveform data is supplied to the D/A converter 32 via the second selecting device 31, and is converted into an analog musical tone signal, which is sounded via the speaker through an amplifier that is not illustrated.

If the MIDI message is another message, a process corresponding to the message is carried out in a step S17. The above described process is repeatedly carried out until the musical composition is performed to the end (step S18).

Usually, in the SMF data, the program change message is written a predetermined period of time (e.g. one beat) before the actual note-on message so as to designate a tone color of the corresponding channel. Thus, even if compressed waveform data is decoded and stored in the second waveform storage 14 in response to the program change message, a time lag never occurs from the note-on message to the actual sounding since the process is completed before sounding in response to the sounding instruction (note-on message). Therefore, the tone generator system 10 according to the present invention is capable of generating musical tones with good responsiveness although the waveform storages having small storage capacities are used.

A description will now be given of 2) a reproducing operation carried out by a tone generator using tone color data (user tone colors) separately prepared by the user.

There are the following three cases of the reproducing operation using user tone colors: a case i) where user tone colors are used with respect to specific one or more MIDI channels and preset tone colors are used with respect to the other MIDI channels; a case ii) where user tone colors are used with respect to specific one or more program numbers and preset tone colors are used with respect to the other program numbers; and a case iii) where tone colors of all program numbers are replaced by user tone colors so that the user tone colors can be used for all tone colors if a tone color set comprised of 128 tone colors, for example, is separately prepared by the user. In any case, tone color data separately prepared by the user and the corresponding PCM waveform data are stored in advance in the user area 53 of the second waveform storage 14. It should be noted that a plurality of user tone colors may be stored in the user area 53 although FIGS. 4A and 4B show a state in which only one user tone color starting from an address BU is stored in the user area 53.

First, a description will be given of the above-mentioned case i) where user tone colors are used with respect to specific one or more MIDI channels.

In this case, the user stores tone color data acquired from the input section 7 (FIG. 1) via the external interface circuit 8 or the communication section 4 and the corresponding PCM waveform data in the user area 53 of the second waveform storage 14. The user sets in advance a mode or the like in which the user tone colors are used with respect to the specific one or more MIDI channels.

Consequently, a start address of an area where the waveform data of the user tone colors is stored in the user area 53 is written into an entry for a MIDI channel designated for the user of the user tone colors in the second tone color index table SO.

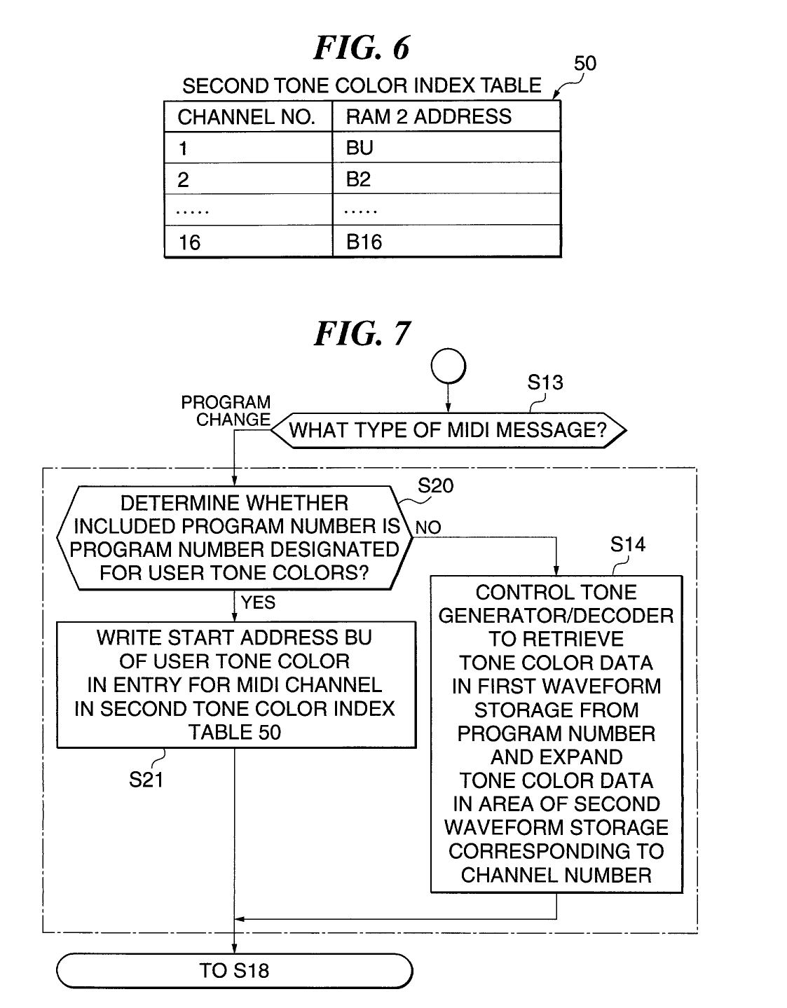

FIG. 6 is a diagram showing data stored in the second tone color index table 50 in a case where user tone colors are used with respect to specific MIDI channels.

The reproducing process is then carried out according to the flow chart of FIG. 5. However, If the MIDI message read in the step S12 is a program change message and a MIDI channel number included in the program change message corresponds to the number of a MIDI channel designated for the use of the user tone colors (if n is equal to 1 in this example), the process in the step S14 is not carried out in response to this program change message.

This enables the reproduction using user tone colors with respect to specific MIDI channels and the reproduction using preset tone colors with respect to the other MIDI channels to be carried out.

A description will now be given of the above-mentioned case (ii) where user tone colors are used with respect to specific one or more program numbers and preset tone colors are used with respect to the other program numbers.

In this case as well, as described above, tone color data prepared by the user and the corresponding PCM waveform data are stored in the user area 53 of the second waveform storage 14, and, The user sets in advance a mode or the like in which the user tone colors are with respect to specific one or more program numbers.

The process is then carried out according to the flow chart of FIG. 5, but in this case, a process enclosed by a broken line in FIG. 7 is carried out instead of the step S14 in FIG. 5.

More specifically, the type of the MIDI message read in the step S13 is determined, and if the MIDI message is a program change message, the program proceeds to a step S20 to determine whether or not a program number (pp) included in the grogram change number is a program number designated for user tone colors (step S20). If it is determined that the program number is a program number designated for user tone colors, the program proceeds to a step S21 to write a start address (BU) of an area where tone color data of user tone colors to be used and the corresponding PCM waveform data are stored in an entry for the corresponding MIDI channel of the second tone color index table 50.

On other hand, if the program number is a program number that is not designated for user tone colors, the step S14 is executed as described above.

The above described process enables the reproduction of a musical composition using tone color data stored in the user area 53 of the second waveform storage 14 without reading out preset tone color data from the first waveform storage 13 and expanding the same in the second waveform storage 14.

A description will now be given of the above-mentioned case (iii) where user tone colors are used for all the tone colors. In this case as well, the user may set a mode in which a user tone color set is used, or a preset bank for using preset tone colors and a user bank for using user tone colors may be defined and the bank to be used may be selected according to a bank select (depending on a control change message of the MIDI message) and a program change message.

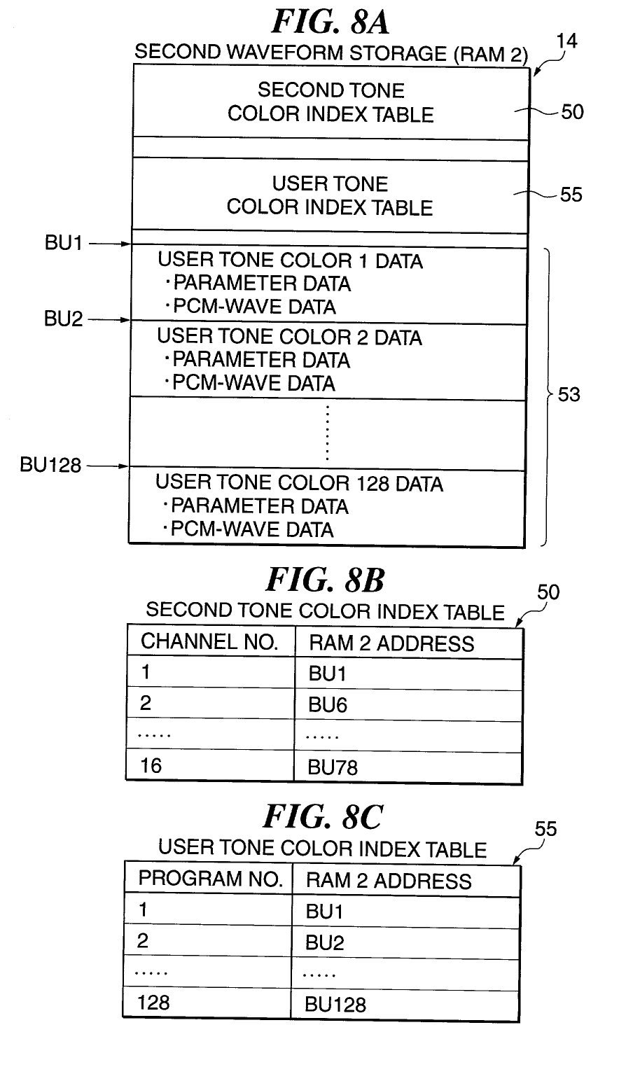

FIGS. 8A-8C are diagrams useful in explaining data stored in the second waveform storage 14, wherein FIG. 8A shows data stored in the second waveform storage 14 in the case of the reproduction using a separately prepared user tone color set, FIG. 8B shows data stored in the second tone color index table 50 in FIG. 8A, and FIG. 8C shows data stored in a user tone color index table 55 in FIG. 8A.

The user tone color index table 55 is information that is included in the above-mentioned user tone color set and designates storage areas for storing the respective tone colors included in the user tone color set. The contents of the user tone color index table 55 are updated according to a storage position of the user tone color set when it is stored in the second waveform storage device 14.

As stated previously, in a mode wherein the user tone color set is used, a tone color set separately prepared by the user is stored in the second waveforms storage 14 under the control of the CPU 1 as shown in the figure. Although the user tone color index table 55 is stored in the second waveform storage 14, the user tone color index table 55 may be provided in the sequencer 11 or the tone generator/decoder section 12 as is the case with the second tone color index table 50.

If the preset tone colors and the user tone colors are switched to one another according to the bank select, the user tone color index table 55 and the user tone color data are stored in the second waveform storage 14 as shown in FIGS. 8A-8C upon detection of a program change message subsequent to the bank select.

The reproducing operation is then carried out according to the flow chart of FIG. 5. In this case, however, in the step S14 that is executed in the case where the MIDI message is a program change message, the start address of the second waveform storage 14 corresponding to a program number included in the program change message is found with reference to the user tone color index table 55, and is written into an entry for the corresponding MIDI channel in the second tone color index table 50.

This enables the reproduction to be carried out using the tone color set separately prepared by the user.

As described above, the tone generator system 10 according to the present embodiment enables the second waveform storage 14 to be used for both the reproduction of preset tone colors and the reproduction of user tone colors, and thus eliminates the necessity of providing another waveform storage for reproducing user tone colors. Therefore, in the reproduction of user tone colors as well as preset tone colors, only a small storage capacity of the storage is required for storing waveform data.

A description will now be given of the above-mentioned 3) reproduction of audio stream data in which longtime compressed waveform data is reproduced.

In this case, the first selector 23 provided at the receiving side of the decoder 24 is switched to select an output from the buffer 22, and the second selector 32 provided at the receiving side of the D/A converter 32 is switched so as to select an output from the decoder 24. The CPU 1 provides the buffer 22 with the audio stream data stored in the second memory 3 and the compressed audio stream data inputted via the communication section 4 or the external interface circuit 8. The compressed stream data is supplied from the buffer 22 to the decoder 24 via the selecting device 23, and is decoded into PCM waveform data, which is supplied to the D/A converter 32 via the second selecting device 31.

This enables compressed audio stream data obtained by the MP3 method, the TwinVQ method, the AAC method, or other methods to be sequentially reproduced.

Although in the above described embodiment, the sequencer 11 and the tone generator/decoder section 12 are implemented by hardware, but both or either one of the sequencer 11 and the tone generator/decoder section 12 may be implemented by software using the CPU 1 or a separately provided CPU.

Further, although in the above described embodiment, the tone generator system 10 according to the present invention is applied to a mobile communication terminal, it may be applied to various kinds of electronic equipment such as electronic musical instruments, game machines, and personal computers.

Further, it goes without saying that the present invention may be accomplished by supplying the system according to the present invention with a storage medium storing a program code of software realizing the functions of the above described embodiment and, and causing a computer (or CPU or MPU) of the system to read out and execute the program code from the storage medium

In this case, the program code itself which is read out from the storage medium realizes the functions of the above described embodiment, and the storage medium storing the program code constitutes the present invention.

The storage medium for recording the program code may be a floppy disk, a hard disk, an optical disk, an magneto-optical disk, a CD-ROM, a CD-R, a DVD-ROM, a semiconductor memory, a magnetic tape, and a nonvolatile memory card, for instance. The program may also be downloaded from another MIDI apparatus or another computer through a communication network.

Further, it goes without saying that the present invention encompasses a case in which the functions of the above described embodiment are accomplished not only by executing the program code read out by the computer, but also by causing an operating system (OS) operating on the computer to perform a part or all of actual operations according to the instructions of the program code.

Further, it goes without saying that the present invention encompasses a case in which the program code read out from the storage medium is written into a memory provided in an expanded function board inserted into the computer or in an expanded function unit connected to the computer, and then a CPU or the like provided in the expanded function board or the expanded function unit performs a part or all of actual operations according to the instructions of the program code so as to accomplish the functions of the above described embodiment.

What is claimed is:

1. A tone generator system comprising:
a first waveform storage that stores compressed waveform data;
a decoder that is responsive to tone color changing instruction data included in musical composition data to be reproduced, for reading out from said first waveform storage the compressed waveform data corresponding to at least one tone color corresponding to the tone color changing instruction data and for decoding the readout compressed waveform data into waveform data in a pulse code modulation format; and
a second waveform storage that stores the waveform data in the pulse code modulation format decoded by said decoder.

2. A tone generator system according to claim 1, further comprising a tone generator section that is responsive to sounding instruction data included in the musical composition data to be reproduced, for generating musical tones based on the waveform data in the pulse code modulation format stored in said second waveform storage.

3. A tone generator system according to claim 1, wherein said second waveform storage is capable of storing waveform data inputted by a user.

4. A tone generator system according to claim 1, wherein said decoder is capable of decoding compressed audio stream data inputted from an external device.

5. A tone generating method comprising:
a decoding step of reading out from a first waveform storage compressed waveform data corresponding to at least one tone color corresponding to tone color changing instruction data included in musical composition data to be reproduced and decoding the readout compressed waveform data into waveform data in a pulse code modulation format, in response to the tone color changing instruction data; and
a waveform storing step of storing in a waveform storage the waveform data in the pulse code modulation format decoded in said decoding step.

6. A program for executing a tone generating method stored in a storage medium readable by a computer, the program comprising:
a decoding module for reading out from a first waveform storage compressed waveform data corresponding to at least one tone color corresponding to tone color changing instruction data included in musical composition data to be reproduced and decoding the readout compressed waveform data into waveform data in a pulse code modulation format, in response to the tone color changing instruction data; and
a waveform storing module for storing in a waveform storage the waveform data in the pulse code modulation format decoded by said decoding module.
